(19) United States
(12) Patent Application Publication
(10) Pub. No.: US 2010/0108282 A1
(43) Pub. Date: May 6, 2010

(54) PRESS FABRIC

(76) Inventors: Fredrik Ewalds, Hogsjo (SE); Hans Ragvald, Vingaker (SE); Jörgen Karlsson, Katrineholm (SE); Lars-Olof Gröndal, Hogsjo (SE)

Correspondence Address: TAYLOR & AUST, P.C., P.O. Box 560, 142. S Main Street, Avilla, IN, 46710, US

(21) Appl. No.: 12/638,376

(22) Filed: Dec. 15, 2009

Related U.S. Application Data
(63) Continuation of application No. PCT/EP2008/052916, filed on May 12, 2008.

(30) Foreign Application Priority Data
Jun. 15, 2007 (DE) DE 102007028365.4

(51) Int. Cl. D21F 3/00; B32B 5/26; B32B 5/06; B32B 7/02

(52) U.S. Cl. 162/358.1

(57) ABSTRACT

The present invention relates to a papermakers felt including a support structure with an upper and a lower side and functional batt layers, wherein at least one of the functional batt layers is needled to the upper side and at least one functional batt layer is needled to the lower side of the support structure. The present invention is characterized in that the support structure includes a base layer and two coarse batt layers, the coarse batt layers mainly including coarse fibers of approximately 67 dtex or more, the two coarse batt layers being disposed on opposite sides of the base layer to provide the upper side and the lower side of the support structure and coarse fibers of each of the two coarse batt layers being embedded in the base layer.

### CROSS REFERENCE TO RELATED APPLICATIONS

This is a continuation of PCT application No. PCT/EP2008/052916, entitled “PRESS FABRIC”, filed Mar. 12, 2008, which is incorporated herein by reference.

### BACKGROUND OF THE INVENTION

1. Field of the Invention

The present invention relates to a papermakers felt for use in a papermaking machine or the like.

2. Description of the Related Art

Especially seamed papermakers felts are used more and more in different press positions. Typically, seamed papermakers felts, also called press fabrics, comprise a woven single support layer to make seaming possible. For wear prone press positions, e.g. due to the use of aggressive filler material for paper production, batt anchorage often is a limitation for the lifetime of such press fabrics. To improve the locking between the batt layers and the woven support layer, woven support layers with multifilament yarns have been designed. In practice these structures often had problems with clogging of the pores leading to unsatisfactory paper production results.

What is needed in the art is a papermakers felt with increased batt layer to support layers bonding without negative influence on the performance of the felt.

### SUMMARY OF THE INVENTION

The present invention provides a papermakers felt including a support structure with an upper and a lower side and functional batt layers, wherein at least one of the functional batt layers is needled to the upper side of the support structure and wherein at least one functional batt layer is needled to the lower side of the support structure. The papermakers felt according to the present invention is further characterized in that the support structure includes a base layer and at least two coarse batt layers, wherein the coarse batt layers primarily include coarse fibers of approximately 67 dtex or more and wherein the two coarse batt layers are disposed on opposite sides of the base layer to provide the upper side and the lower side of the support structure and, further, coarse fibers of each of the two coarse batt layers are embedded in the base layer.

In other words, the support structure is made from a base layer sandwiched between two coarse batt layers, a first and a second coarse batt layer. According to the present invention, coarse fibers of each of the coarse batt layers are embedded into the base layer. Therefore, coarse fibers of the at least one coarse batt layer disposed on the one side of the base layer extend from the coarse layer(s) into and/or through the support layer and coarse fibers of the at least one coarse batt layer disposed on the side of the base layer opposite to the one side (second coarse batt layer) extend from the coarse layer(s) into and/or through the support layer, resulting in that coarse fibers of the first and of the second coarse batt layer are embedded in the support layer. For purposes of delineating the present invention, when referring to first coarse batt layers, coarse batt layers disposed on the one side of the base layer are meant and when referring to second coarse batt layers, coarse batt layers disposed on the side opposite to the one side of the base layer are meant.

To manufacture the support structure according to the present invention, in a first step, the first coarse batt layer is disposed on the upper side of the base layer and the second coarse layer is disposed on the lower side of the base layer to provide a sandwich made of the first coarse layer, the base layer and the second coarse layer. In a second step, the sandwich is needled from the first and from the second coarse layer. Due to needling, coarse fibers of the first coarse layer and coarse fibers of the second coarse layer are embedded in the base layer.

The present invention is based, on the one hand, on the idea that good attachment of a functional batt layer (e.g. a batt layer with fine fibers) mainly is possible if this functional batt layer is needled to another batt layer and not to a woven base layer. The present invention is further based, on the other hand, on the idea that only coarse fibers can give a good attachment between a batt layer and a base layer, e.g. woven fabric, without negatively influencing other properties, e.g. as dewatering and/or conditioning.

Based on the fact that coarse fibers with a coarseness of at least approximately 67 dtex are embedded from both sides in the base layer, a support structure is provided with improved anchorage for the functional batt layers needled onto the coarse batt layers as compared to the anchorage of functional batt layers needled onto a support structure made from monofilament yarns.

Further, based on the fact that coarse fibers with a coarseness of at least 67 dtex are embedded from both sides in the base layer, a support structure is provided without the disadvantages known from prior art papermakers felts which have been developed to provide improved anchorage. Such papermakers felts have support structures made from multifilament yarns. Such multifilament yarn support structures, mainly woven structures or link structures, made from multifilament yarns have reduced permeability and reduced seamability compared to support structures made from monofilament yarns.

The papermakers felt according to the present invention provides a support structure combining the advantages of both above mentioned support structures.

Depending on the specific requirements, the coarse fibers of the two coarse batt layers can either be MD or CD or random orientated. If it is said that the fibers are orientated in a specific direction, it is clear that due to limits in production accuracy it can be that not all of the coarse fibers are orientated in the desired direction, but that most of the fibers are orientated in this direction.

Further, it can be that the coarse fibers of the first coarse batt layer are orientated differently to the coarse fibers of the second coarse batt layer.

According to a first embodiment of the present invention, coarse fibers of the first coarse batt layer(s) are embedded in the second coarse batt layer(s) and extend through the base layer and vice versa.

This provides a support structure with improved resistance to delamination of each of the two coarse batt layers, because each coarse batt layer is locked from delaminating of the base layer by the coarse batt layer on the opposite side of the base layer, as a result of the coarse fibers of each coarse batt layer being embedded in the coarse batt layer on the opposite side of the base layer.

The base layer of the fabric according to the present invention can include at least one of a textile layer and a non-textile layer. The textile layer can include at least one of a woven fabric, a link fabric, an array of MD and/or CD yarns, or a combination thereof. Further, on the textile layer can be a woven fabric, a link fabric, an array of MD and/or CD yarns. If the base layer is a textile layer, the textile layer may be made from monofilament yarns and if the papermakers felt is a seamed felt, because the papermakers felt with the inventive support structure provides good attachment of the functional fiber batts to the support structure because of the monofilament base layer, may be easy to seam and have a very open structure.

Further, the non-textile layer can include at least one of a membrane and a laminate.

According to a second embodiment of the present invention, the coarseness of the coarse fibers of the coarse batt layers are between approximately 67 and 300 dtex. Typical suitable values are, e.g., 67 dtex, 100 dtex, 200 dtex, 250 dtex or 300 dtex.

Further, all of the coarse fibers in a coarse batt layer can have the same coarseness, respectively the same dtex value. Independent from that, one or both of the two coarse batt layers can further include in a lower amount finer fibers, or fibers with a coarseness of less than approximately 67 dtex.

To improve the inner bonding of the coarse batt layers according to a further improvement, it is foreseen that at least some of the coarse fibers of at least one of the coarse batt layers are bonded together by adhesive means. To further improve the attachment of a coarse batt layer to the base layer, at least one of the coarse batt layers can further be bonded to the base layer by adhesive means.

The inner layer bonding of a coarse batt layer and the bonding of a coarse batt layer to the base layer may be achieved if the percentage component by weight of the coarse batt layer of the adhesive means is between 5% and 40% of the coarse batt layer.

During production of the papermakers felt, the felt is subjected to a heat set treatment, where heat at a heat set temperature and tension is supplied simultaneously to the fabric. One possible way to provide the adhesive means is to provide fibers which melt at the heat set temperature. During heat set treatment, the low melt fibers melt and bond together coarse fibers of the first coarse batt layer with other coarse fibers of the first coarse batt layer and/or with coarse fibers of the second coarse batt layer and/or with yarns of the base layer such that an integrated support structure is provided.

According to a third embodiment of the present invention, the adhesive means include bi-component fibers, one component having a melting temperature such that it melts at the heat set temperature. The bi-component fibers include a first component with a melting temperature lower than the melting temperature of the second component of the bi-component fibers and which is sufficiently low that it melts during heat set treatment of the papermakers felt.

The adhesive means may further include a sheath around the coarse fibers, the sheath configured to melt at heat set temperature.

According to a fourth embodiment of the present invention, the fibers of the functional batt layers are less coarse than the coarse fibers of the coarse batt layers. Typically, functional batt layers have a coarseness in the range from approximately 3.3 dtex up to approximately 44 dtex. Coarse batt layers are mainly relevant to prevent the papermakers felt from delamination were as finer fiber batt layers are to provide high wear resistance on the machine side and a smooth paper side with good wood fiber support.

According to a fifth embodiment of the present invention, the felt includes two or more functional top batt layers needled to the upper side of the support structure, wherein the outer of the functional top batt layers—this is the top batt layer which is not sandwiched between other layers of the papermakers fabric—provides the paper receiving side of said papermakers felt.

To provide a papermakers felt with a smooth and non-sheet marking paper side, the coarseness of the outer functional top batt layer is less than the coarseness of other functional top batt layers. Typically, the outer functional top batt layer that provides the paper side of the papermakers felt can include fibers in the range from approximately 3.3 dtex to approximately 22 dtex, whereas the other functional top batt layers typically include fibers in the range from approximately 11 dtex to approximately 44 dtex.

To provide a wear resistant papermakers felt, the felt further includes at least one functional bottom batt layer needled to the lower side of the support structure. It can be that a functional top batt layer and/or a functional bottom batt layer only include fibers of a certain dtex value or that it includes fibers having different dtex values.

According to an embodiment of the present invention, the total thickness of all functional bottom batt layers may be less than the total thickness of all functional top batt layers.

According to a sixth embodiment, the papermakers felt of the present invention is a seamed felt.

The invention will be described in more detail by the following, schematically drawing.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 illustrates a papermakers felt according to the present invention

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

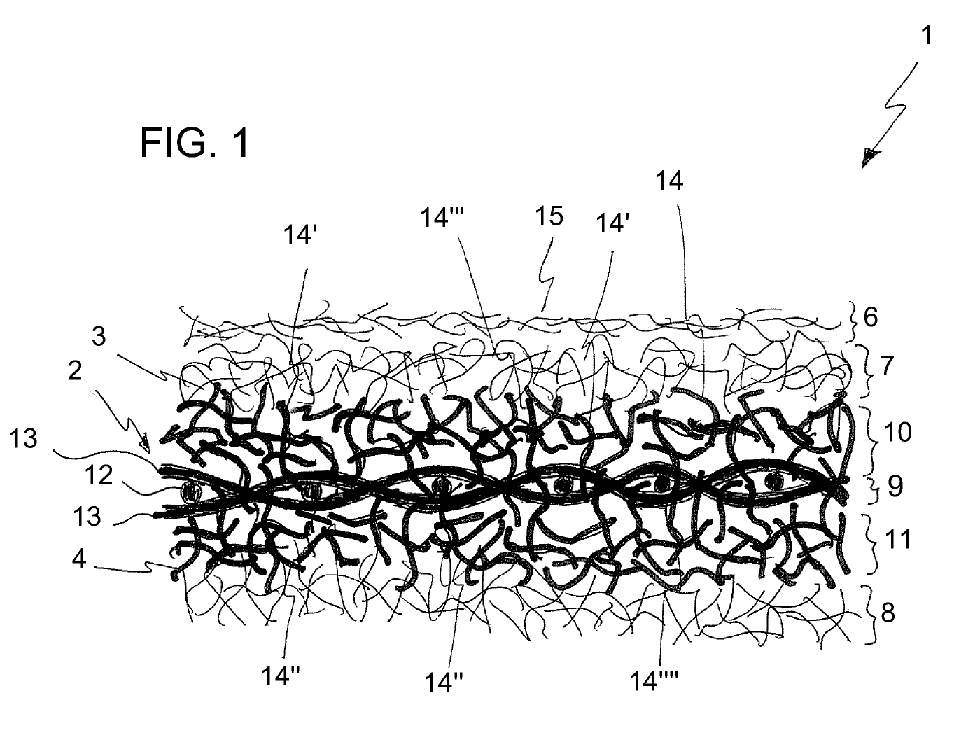

Referring now to the drawing, and more particularly to FIG. 1, there is shown an embodiment of seamed papermakers felt 1 according to the present invention. Felt 1 includes support structure 2 with upper side 3 and lower side 4. Felt 1 further includes two functional top batt layers 6, 7 needled to upper side 3 of the support structure. Outer functional top batt layer 6 of two functional top batt layers 6, 7 provides paper receiving side 15 of papermakers felt 1. The coarseness of outer functional top batt layer 6 is less than the coarseness of subjacent functional top batt layer 7. By way of non-limiting example, the fibers of outer functional top batt layer 6 have a coarseness of approximately 6.6 dtex, whereas the fibers of subjacent functional top batt layer 7 is approximately 33 dtex.

Papermakers felt 1 further includes functional bottom batt layer 8 providing the machine side of felt 1. Functional bottom batt layer 8 is needled to lower side 4 of the support structure. Functional bottom batt layer 8 is made of fibers of approximately 44 dtex. The total thickness of functional bottom batt layer 8 is less than the total thickness of functional top batt layers 6 and 7 together.

As can be seen, support structure 2 is made from base layer 9, which is woven from monofilament weft yarns 12 and monofilament warp yarns 13. Support structure 2 further includes two coarse batt layers 10, 11.

According to the present invention, coarse batt layers 10, 11 mainly include coarse fibers 14 of approximately 100 dtex. In both coarse batt layers 10, 11, coarse fibers 14 all have the same coarseness. Two coarse batt layers 10, 11 are disposed on opposite sides of woven base layer 9 to provide upper side 3 and lower side 4 of support structure 2.

Further, some of coarse fibers 14 of each of two coarse batt layers 10, 11 are embedded in woven base layer 9. For example, coarse fibers 14′ of (first) coarse batt layer 10 extend from coarse layer 10 into and/or through woven support layer 9 and coarse fibers 14″ of (second) coarse batt layer 11 extend from coarse layer 11 into and/or through support layer 9 resulting in that coarse fibers of first coarse batt layer 10 and of second coarse batt layer 11 are embedded in support layer 9.

In addition, coarse fibers 14′″ of first coarse batt layer 10 are embedded in second coarse batt layer 11 by extending through woven base layer 9 into second coarse batt layer 11 and coarse fibers 14″″ of second coarse batt layer 11 are embedded in first coarse batt layer 10 by extending through woven base layer 9 into the first coarse batt layer 10.

To further improve the inner stability of coarse batt layer 10, some of coarse fibers 14 in coarse batt layer 10 are bonded together by adhesive means provided by low melt sheaths around coarse fibers 14 which melt at heat set temperature during production of the felt.

To further improve the inner stability of coarse batt layer 11, some of coarse fibers 14 in coarse batt layer 11 are bonded together by adhesive means provided by low melt sheaths around coarse fibers 14 which melt at heat set temperature during production of the felt.

To further improve the attachment of each of coarse batt layers 10, 11 to the woven base layer 9, at least some, for example all, of coarse fibers 14′ to 14″″ which are embedded in woven base layer 9 further are bonded by the adhesive means to base layer 9. As before, the adhesive means are provided by low melt sheaths around coarse fibers 14 which melt at heat set temperature during production of the felt.

The percentage component by weight of coarse batt layer 10, 11 of the adhesive means is between approximately 5% and 40%, e.g. 10%, of coarse batt layer 10, 11.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A papermakers felt comprising:
a support structure having an upper side and a lower side, said support structure comprising:
a base layer; and
two coarse batt layers, each of said two coarse batt layers being on opposing sides of said base layer to form said upper side of said support structure and said lower side of said support structure, wherein each of said two coarse batt layers includes coarse fibers of at least approximately 67 dtex, said coarse fibers of each of said two coarse batt layers being embedded in said base layer; and
a plurality of functional batt layers, wherein at least one of said functional batt layers is needled to said upper side of said support structure and at least one second functional batt layer is needled to said lower side of said support structure.

2. The papermakers felt according to claim 1, wherein said two coarse batt layers includes a first coarse batt layer including a first set of coarse fibers and a second coarse batt layer including a second set of coarse fibers, said first set of coarse fibers extending through said base layer and being embedded in said second coarse batt layer and vice versa.

3. The papermakers felt according to claim 2, wherein said base layer includes at least one of a textile layer and a non-textile layer.

4. The papermakers felt according to claim 3, wherein said textile layer includes at least one of a woven fabric, a link fabric and an array of at least one of MD and an array of CD yarns.

5. The papermakers felt according to claim 4, wherein said textile layer is formed of monofilament yarns.

6. The papermakers felt according to claim 3, wherein said non-textile layer includes at least one of a membrane and a laminate.

7. The papermakers felt according to claim 1, wherein a coarseness of said coarse fibers of said two coarse batt layers is between approximately 67 dtex and 300 dtex.

8. The papermakers felt according to claim 1, wherein all of said coarse fibers of said two coarse batt layers have the same coarseness.

9. The papermakers felt according to claim 1, wherein at least a portion of said coarse fibers of at least one of said two coarse batt layers are bonded together by adhesive means.

10. The papermakers felt according to claim 9, wherein at least one of said two coarse batt layers is bonded to said base layer by said adhesive means.

11. The papermakers felt according to claim 10, wherein a percentage by weight said of adhesive means of one of said two coarse batt layers is between approximately 5% and 40% of said one coarse batt layer.

12. The papermakers felt according to claim 11, said adhesive means including fibers which melt at a heat set temperature.

13. The papermakers felt according to claim 12, said adhesive means including bi-component fibers, wherein one component of said bi-component fibers melts at said heat set temperature.

14. The papermakers felt according to claim 13, said adhesive means including a sheath around said coarse fibers, wherein said sheath melts at said heat set temperature.

15. The papermakers felt according to claim 14, wherein said functional batt layers include a plurality of fibers less coarse than said fibers of said two coarse batt layers.

16. The papermakers felt according to claim 15, said plurality of functional batt layers includes at least two functional batt layers needled to said upper side of said support structure, wherein an outer functional batt layer of said at least two functional batt layers provides a paper receiving side of the papermakers felt.

17. The papermakers felt according to claim 16, wherein said coarseness of said outer functional top batt layer is less than a second coarseness of another functional top batt layer.

18. The papermakers felt according to claim 17, wherein said plurality of functional batt layers including at least one functional bottom batt layer needled to said lower side of said support structure.

19. The papermakers felt according to claim 18, wherein a total thickness of all of said functional bottom batt layers is less than a total thickness of all of said functional top batt layers.

20. The papermakers felt according to claim 19, wherein the papermakers felt is a seamed felt.
